(19) United States
(12) Patent Application Publication
(10) Pub. No.: US 2020/0283046 A1
(43) Pub. Date: Sep. 10, 2020

(54) FOLDABLE TROLLEY

(71) Applicant: Ningbo Casualway Leisure Products Co., Ltd., NINGBO (CN)

(72) Inventor: Guoxiang WU, NINGBO (CN)

(73) Assignee: Ningbo Casualway Leisure Products Co., Ltd.

(21) Appl. No.: 16/807,158

(22) Filed: Mar. 2, 2020

(30) Foreign Application Priority Data
Mar. 8, 2019 (CN) 201910176781.2

(51) Int. Cl. B62B 3/02

(52) U.S. Cl. CPC B62B 3/02; B62B 2205/06

(57) ABSTRACT

The present disclosure discloses a foldable trolley, comprising a pull rod assembly, a front support, a rear support, an underframe folding assembly, a side frame folding assembly and a roller set; one end of the underframe folding assembly is hinged with the bottom of the front support, while the other end of the underframe folding assembly hinged with the bottom of the rear support; both sides of the front support and the rear support are connected with the side frame folding assemblies. Due to the arrangement of the underframe folding assembly and the side frame folding assembly, the trolley is contractile for folding in the front-back direction, occupying less space when the trolley is folded, and articles are transported when the trolley is unfolded, being convenient to carry.

### CROSS-REFERENCE TO RELATED APPLICATIONS

This application claims priority to Chinese Patent Application No. 201910176781.2 with a filing date of Mar. 8, 2019. The content of the aforementioned application, including any intervening amendments thereto, are incorporated herein by reference.

### TECHNICAL FIELD

The present disclosure relates to the technical field of trolleys, in particular to a foldable trolley.

### BACKGROUND

With the improvement of living standard, more and more people are fond of self-driving for outdoor activities, taking along a good deal of picnic foods and outdoor utensils. However, in view of the fact that the self-driving automobiles are merely allowed to be driven to the parking lot, people have to walk all the remaining distance to their destinations, thus it is such a burden for them to carry so many things while walking. Specific to this issue, a foldable trolley that can be placed into the back trunk of the vehicle merges in the market. When in use, the trolley is unfolded to transport the picnic foods and outdoor utensils, making it easier for manual handling. Whereas, the existing trolley generally adopts a translation-foldable type, and is formed by cross articulation of steel tubes to form a group of X-shape cross tube for foldable placement. It's of simple structure, but when the trolley is retracted for folding, such a structure leads to a relatively long length of the folded trolley, inconvenience to carry and occupies more space in the trunk. Besides, the trolley of the above structure is weak in side support strength, as except for a central cross point at each side when the structure is unfolded, the steel tubes are placed in the form of bevel edges inclined from two ends toward the cross point, providing poor side shielding and support capability, low side protection for transported articles in the trolley, high possibility of articles sliding out of the trolley when it moves, and weakened actual loading capability of the trolley. Moreover, in case of sheathing the trolley with a cloth cover, with only a central cross point at the upper edge of each side as a fixation point, the cloth cover is easy to collapse and fall off due to insufficient support. Consequently, it is a problem urgently needed to be resolved presently, i.e., how to reduce the folded size of the trolley, meanwhile improve and enhance side shielding and support strength of the trolley and increase the actual loading capability of the trolley while maintaining its capability unchangeable when unfolded.

### SUMMARY

As far as the situation of the prior art is concerned, the technical problem to be solved by the present disclosure is to provide a foldable trolley with good bearing strength, small contraction volume, and of convenience to carry.

The technical solution adopted to resolve the above technical problem in the present disclosure provides a foldable trolley, comprising a pull rod assembly, a front support, a rear support, an underframe folding assembly, a side frame folding assembly and a roller set; one end of the underframe folding assembly is hinged with the bottom of the front support, while the other end of the underframe folding assembly hinged with the bottom of the rear support; both sides of the front support and the rear support are connected with the side frame folding assemblies; the roller set is respectively connected to the bottom of the front support and the bottom of the rear support; the pull rod assembly is connected to the front support; the trolley presents a platy shape when in folding, and a rectangular shape when in unfolding.

In some embodiment, both the front and rear supports are in the shape of closed rectangles, and are provided with an upper cross beam, a lower cross beam and two vertical beams respectively.

In some embodiment, auxiliary beams are provided below the upper cross beams of both the front and rear supports.

In some embodiment, each side frame folding assembly comprises a first long cross tube, a second long cross tube, a first short cross tube, a second short cross tube, a first connecting tube and a second connecting tube; the lower end of the first long cross tube is hinged with the lower end of the vertical beam of the front support; the upper end of the first long cross tube is hinged with the upper end of the second long cross tube to form a first hinging position; the lower end of the second long cross tube is hinged with the lower end of the vertical beam of the rear support; the lower end of the first short cross tube is hinged with the lower end of the second short cross tube to form a second hinging position; the upper end of the first short cross tube is hinged with one end of the first connecting tube; the other end of the first connecting tube is hinged with the upper end of the vertical beam of the front support; the upper end of the second short cross tube is hinged with one end of the second connecting tube; the other end of the second connecting tube is hinged with the upper end of the vertical beam of the rear support; the first short cross tube and the first long cross tube are mutually crosswise hinged; and the second short cross tube and the second long cross tube are mutually crosswise hinged.

In some embodiment, a supporting tube is provided between the second hinging positions and the supporting tube is located below the underframe folding assembly.

In some embodiment, when the trolley is unfolded, an included angle A of 80-90° is formed between the first connecting tube and the vertical beam of the front support, and another included angle B of 80-90° is formed between the second connecting tube and the vertical beam of the rear support; the first connecting tube, the second connecting tube and the first hinging position are at the same horizontal plane; and when the trolley is folded, the first connecting tube and the vertical beam of the front support have an included angle a of less than 10°, and the second connecting tube and the vertical beam of the rear support have an included angle b of less than 10°.

In some embodiment, the roller set comprises two front wheels and two rear wheels; the front wheels are connected to the lower cross beam of the front support and the rear wheels are connected to the lower cross beam of the rear support.

In some embodiment, the pull rod assembly comprises a first telescopic rod, a second telescopic rod and a handle; the lower end of the first telescopic rod is rotatably connected with the lower cross beam of the front support, and the upper end of the first telescopic rod is sleeved outside the lower end of the second telescopic rod; the sleeved part of the first and second telescopic rods is provided with a lock latch; the handle is mounted at the upper end of the second telescopic rod; the upper cross beam of the front support is provided with a limit clamp for clamping the first telescopic rod.

In some embodiment, the underframe folding assembly comprises a front underframe and a rear underframe, the front end of the front underframe is hinged inside the lower end of the vertical beam of the front support, the front end of the rear underframe is hinged inside the lower end of the vertical beam of the rear support, and the rear end of the rear underframe is hinged with the rear end of the front underframe.

In some embodiment, both the front and rear underframes are provided with a plurality of bearing beams respectively.

The foldable trolley disclosed in the present disclosure has the following advantages as compared to the prior art: by arranging the underframe folding assembly and the side frame folding assembly, the trolley is contractile for folding in the front-back direction, occupying less space when the trolley is folded, and articles are transported when the trolley is unfolded, being convenient to carry. Each side frame folding assembly comprises a first long cross tube, a second long cross tube, a first short cross tube, a second short cross tube, a first connecting tube and a second connecting tube that are all in hinged match, i.e., a double-cross folding structure is formed, therefore, ensures a firm structure and a good bearing and shock resistance, and the height of the folded trolley is less than the length of the unfolded trolley so as to reduce folding volume. Besides, the first and second connecting tubes render the cloth cover in the trolley be conveniently propped open. Further, a support point is provided in the center, and the first and second connecting tubes are arranged at two sides for horizontal support, avoiding collapse of the peripheral edges of the cloth cover to cause falling off of articles, improving side shielding capability and ensuring capacity of the trolley.

### BRIEF DESCRIPTION OF THE DRAWINGS

FIG. 1 is a schematically structural diagram of the foldable trolley of the present disclosure in an unfolded state.

FIG. 2 is a side view of FIG. 1.

FIG. 3 is an exploded view of a side frame folding assembly of the present disclosure.

FIG. 4 is a schematically structural diagram of the foldable trolley of the present disclosure in a semi-unfolded state.

FIG. 5 is a schematically structural diagram of the foldable trolley of the present disclosure in a folded state.

FIG. 6 is a side view of FIG. 5.

FIG. 7 is a schematically structural diagram of the foldable trolley of the present disclosure with auxiliary beams.

Among them, 1 pull rod assembly; 1.1 first telescopic rod; 1.2 second telescopic rod; 1.3 handle; 1.4 lock batch; 2 front support; 2.1 upper cross beam; 2.2 lower cross beam; 2.3 vertical beam; 3 rear support; 3.1 upper cross beam; 3.2 lower cross beam; 3.3 vertical beam; 4 underframe folding assembly; 4.1 front underframe; 4.2 rear underframe; 4.3 bearing beam; 5 side frame folding assembly; 5.1 first long cross tube; 5.2 second long cross tube; 5.3 first short cross tube; 5.4 second short cross tube; 5.5 first connecting tube; 5.6 second connecting tube; 5.7 first hinging position; 5.8 second hinging position; 5.9 first hinging part; 5.10 second hinging part; 5.11 third hinging part; 5.12 fourth hinging part; 6 roller set; 6.1 front wheel; 6.2 rear wheel; 6.3 brake part; 7 supporting tube; 8 limit clamp.

### DETAILED DESCRIPTION OF THE EMBODIMENTS

Various aspects of the illustrative embodiments of the present disclosure will be described herein using terms commonly employed by those skilled in the art. However, it will be apparent to those skilled in the art that alternate embodiments may be practiced with only some of the described aspects. For purposes of explanation, specific numbers, materials and configurations are set forth in order to provide a thorough understanding of the illustrative embodiments. It will be apparent that alternate embodiments may be practiced without the specific details. In other instances, well-known features are omitted or simplified in order not to obscure the illustrative embodiments.

It will be understood that, although the terms “first”, “second”, “third”, etc. may be used herein to describe various elements, these elements should not be limited by these terms to indicate or imply any relative importance. These terms are only used to distinguish one element from another. For example, a first element could be termed a second element without departing from the scope of the present disclosure. The terms “center”, “upper”, “lower”, “left”, “right”, “vertical”, “lateral”, “inner”, “outer”, etc. may indicate directions or positions as illustrated in some of the drawings. These terms are only used in order not to obscure the description, and should not be construed as an indication of a particular position relation or sequence. As used herein, the term “and/or” includes any and all combinations of one or more of the associated listed items.

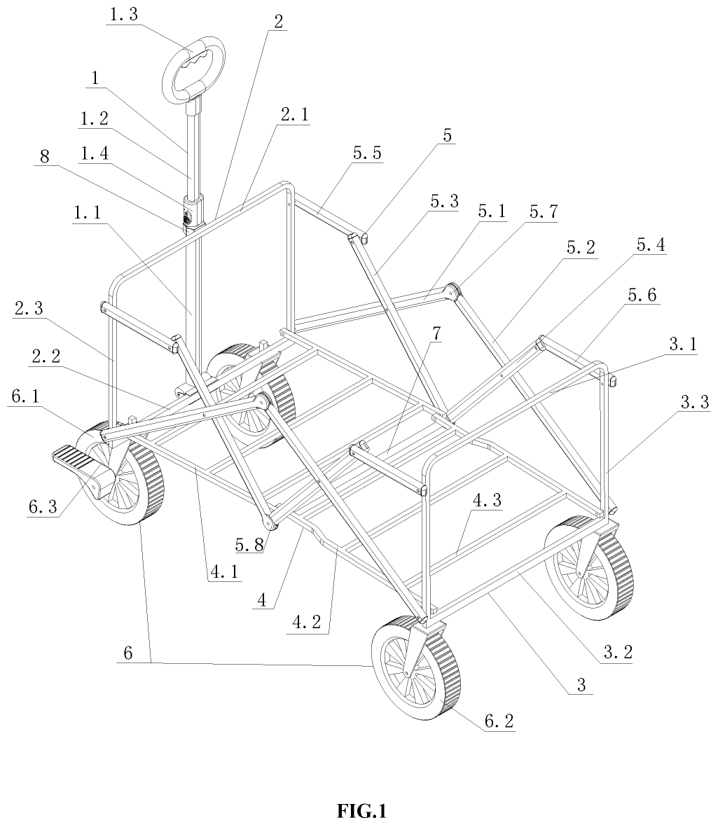

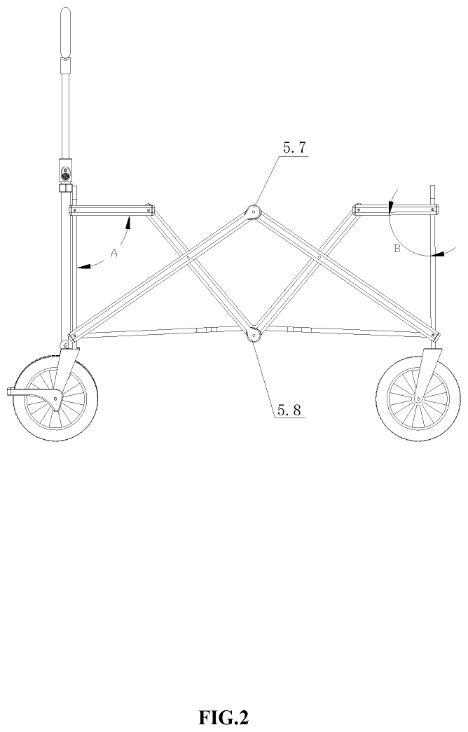

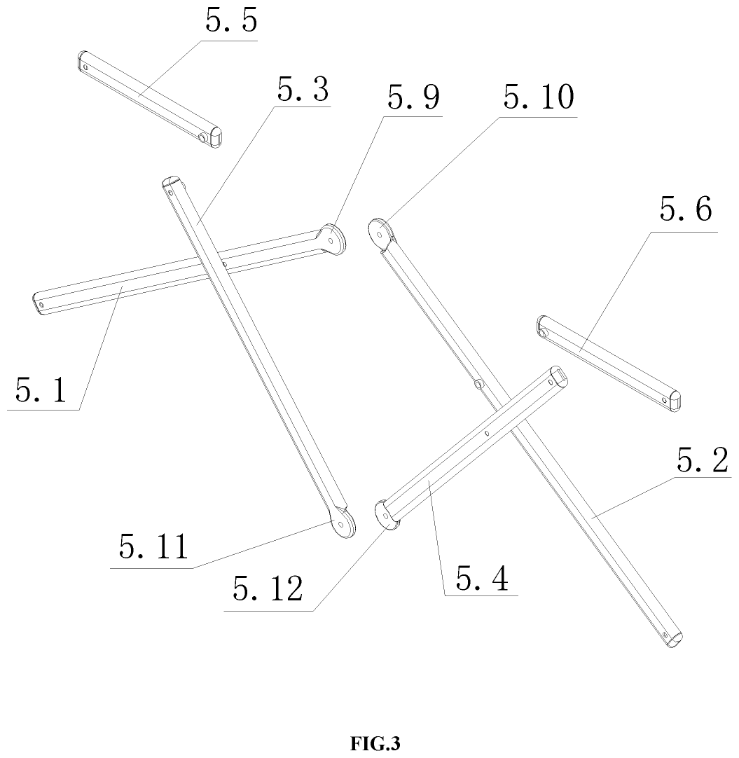

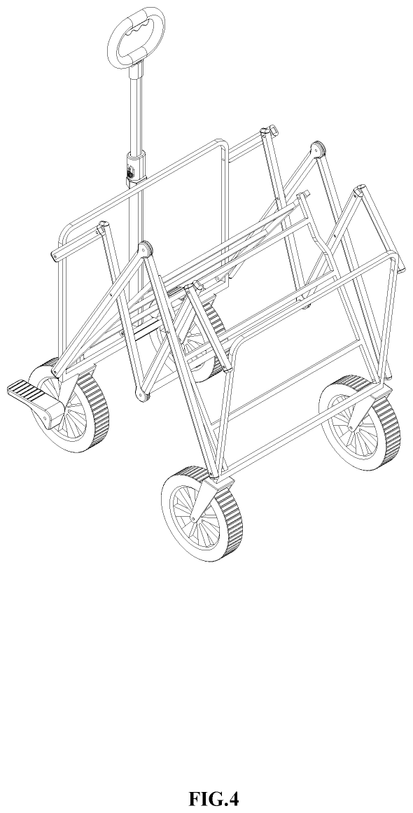

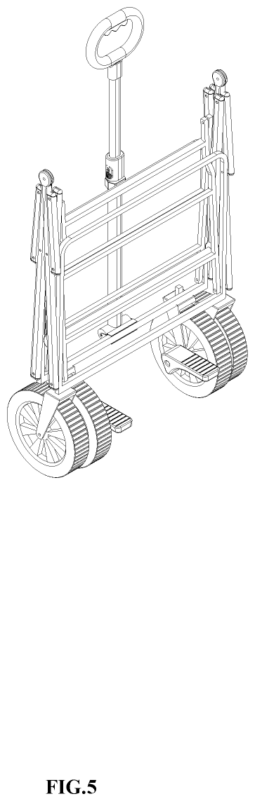

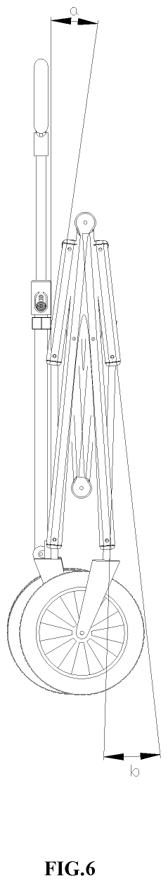

As shown in FIGS. 1-7, a folded trolley comprises a pull rod assembly 1, a front support 2, a rear support 3, an underframe folding assembly 4, a side frame folding assembly 5 and a roller set 6; both the front support 2 and the rear support 3 take on closed rectangles, feature in improved stability and high strength, and are provided with an upper cross beam, a lower cross beam and two vertical beams respectively. One end of the underframe folding assembly 4 is hinged with the bottom inside of the front support 2, while the other end thereof is hinged with the bottom inside of the rear support 3. The side frame folding assembly 5 are connected to two sides of the front support 2 and the rear support 3. The roller set 6 is respectively connected to the bottom of the front support 2 and the bottom of the rear support 3. The pull rod assembly 1 is connected to the front support 2. The trolley presents a platy shape when in folding so as to have a small volume and be convenient to carry. The trolley is of a rectangular shape when in unfolding for articles transportation.

Each side frame folding assembly 5 comprises a first long cross tube 5.1, a second long cross tube 5.2, a first short cross tube 5.3, a second short cross tube 5.4, a first connecting tube 5.5 and a second connecting tube 5.6; the first long cross tube 5.1 and the second long cross tube 5.2 have the same shape and are in bilateral symmetry; the first short cross tube 5.3 and the second short cross tube 5.4 have the same shape and are in bilateral symmetry; the first connecting tube 5.5 and the second connecting tube 5.6 have the same shape and are in bilateral symmetry; the first long cross tube 5.1 is longer than the first short cross tube 5.3; the first short cross tube 5.3 is longer than the first connecting tube 5.5; the lower end of the first long cross tube 5.1 is hinged with the lower end of the vertical beam 2.3 of the front support 2; the upper end of the first long cross tube 5.1 is hinged with the upper end of the second long cross tube 5.2 to form a first hinging position 5.7; the lower end of the second long cross tube 5.2 is hinged with the lower end of the vertical beam 3.3 of the rear support 3; the lower end of the first short cross tube 5.3 is hinged with the lower end of the second short cross tube 5.4 to form a second hinging position 5.8; the upper end of the first short cross tube 5.3 is hinged with one end of the first connecting tube 5.5; the other end of the first connecting tube 5.5 is hinged with the upper end of the vertical beam 2.3 of the front support 2; the upper end of the second short cross tube 5.4 is hinged with one end of the second connecting tube 5.6; the other end of the second connecting tube 5.6 is hinged with the upper end of the vertical beam 3.3 of the rear support 3; the first short cross tube 5.3 and the first long cross tube 5.1 are mutually crosswise hinged; and the second short cross tube 5.4 and the second long cross tube 5.2 are mutually crosswise hinged such that height of the folded trolley equals to the length of the first long cross tube 5.1, but the first long cross tube 5.1 is shorter than the unfolded trolley, thereby lowering height of the folded trolley and reducing occupied space while ensuring capability of the unfolded trolley unchangeable, thus being convenient to carry. In addition, the first long cross tube 5.1, the second long cross tube 5.2, the first short cross tube 5.3, the second short cross tube 5.4, the first connecting tube 5.5 and the second connecting tube 5.6 are all in hinged match, i.e., a double-cross folding structure is formed, therefore, the trolley is enhanced in firmness, improved in side support strength, good in bearing and shock resistance, and capable of preventing articles from falling off.

Preferably, when the trolley is unfolded, the upper cross beams of the front support 2 and the rear support 3 may be disposed in various ways, for example, the upper cross beams of the front support 2 and the rear support 3 level with the first connecting tube 5.5 and the second connecting tube 5.6 so as to be applicable to a cloth cover with equal-height periphery after being propped open to ensure smooth distraction of the cloth cover. Furthermore, for example, the structure that the upper cross beams of the front support 2 and the rear support 3 are higher than the first connecting tube 5.5 and the second connecting tube 5.6 is applicable to a cloth cover of which the front and rear sides are higher than two sides after being propped open, and the cloth cover with this structure is favorable of enhancing protection on front and rear of articles in the trolley, and preventing the articles from falling off from the trolley due to inertia.

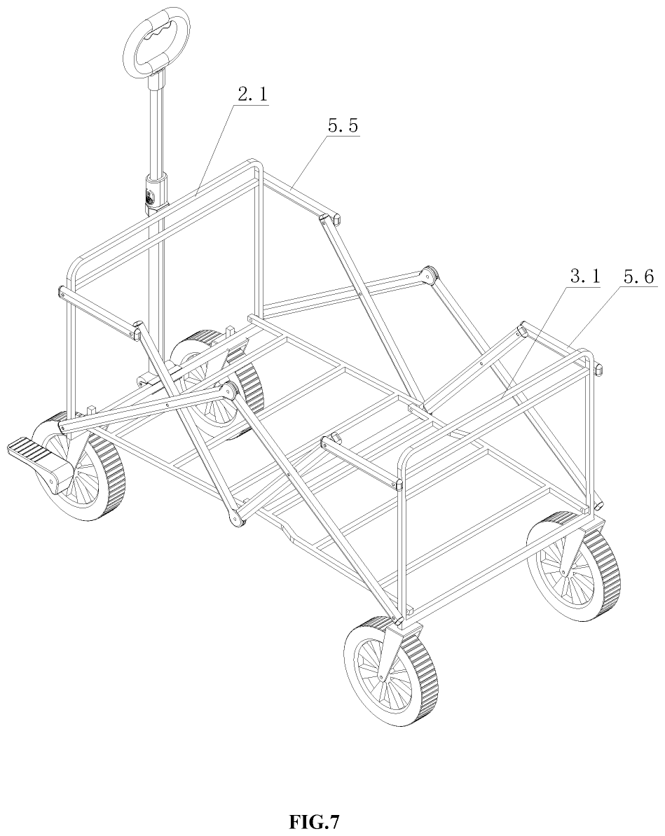

Preferably, as shown in FIG. 7, auxiliary beams are provided below the upper cross beams of the front support 2 and the rear support 3. These auxiliary beams level with the first connecting tube 5.5 and the second connecting tube 5.6. The above structure is applicable to a cloth cover with equal-height periphery after being propped open to ensure smooth distraction of the cloth cover. Moreover, the upper cross beams of the front support 2 and the rear support 3 play a role in enhancing protection on front and rear of articles in the trolley, and preventing the articles from falling off from the trolley due to inertia.

A supporting tube 7 is provided between the second hinging positions 5.8, the supporting tube 7 is located below the underframe folding assembly 4 for supporting the underframe folding assembly 4 and assisting the underframe folding assembly 4 in bearing weight of articles. It also can share the borne force to the side frame folding assembly 5 to improve stability of the trolley. What's more, the supporting tube 7 also plays a part in limiting the underframe folding assembly 4, i.e., preventing the underframe folding assembly 4 from undue downward rotation to influence the bearing effect of the trolley.

When the trolley is unfolded, the first connecting tube 5.5 and the vertical beam 2.3 of the front support 2 have an included angle A of 80-90°, the second connecting tube 5.6 and the vertical beam 3.3 of the rear support 3 have an included angle B of 80-90°, and the first connecting tube 5.5, the second connecting tube 5.6 and the first hinging position 5.7 are located at the same horizontal plane, in this case, a cloth cover is convenient to mount, not only is middle support to the cloth cover provided, but also the first connecting tube 5.5 and the second connecting tube 5.6 at two ends may provide transverse support to the cloth cover in the horizontal direction, thereby ensuring that the cloth cover has a leveled periphery after propped open and low possibility of collapse of lateral sides, and effectively prevents falling off of articles from the lateral sides. The first connecting tube 5.5, the second connecting tube 5.6 and the hinging part 5.7 are matched to one another to smoothly prop the cloth cover open, thus preventing collapsed periphery of the cloth cover from influencing capacity of the trolley and improving support strength. When the trolley is folded, the first connecting tube 5.5 and the vertical beam 2.3 of the front support 2 have an included angle a of less than 10°, and the second connecting tube 5.6 and the vertical beam 3.3 of the rear support 3 have an included angle b of less than 10°, to guarantee a small folding volume.

Preferably, the upper end of the first long cross tube 5.1 is provided with a first hinging part 5.9 with the thickness halved that of the first long cross tube 5.1; the upper end of the second long cross tube 5.2 is provided with a second hinging part 5.10 with the thickness halved that of the second long cross tube 5.2; the first hinging part 5.9 and the second hinging part 5.10 are hinged to make the first long cross tube 5.1 and the second long cross tube 5.2 located in the same plane during relative rotation and prevent difference of level between the first long cross tube 5.1 and the second long cross tube 5.2 after connected, therefore, folding volume is reduced, and folded contraction of the other tubes is not influenced by tube malposition due to the thicknesses of tubes. The lower end of the first short cross tube 5.3 is provided with a third hinging part 5.11 with the thickness halved that of the first short cross tube 5.3; the lower end of the second short cross tube 5.4 is provided with a fourth hinging part 5.12 with the thickness halved that of the second short cross tube 5.4; the third hinging part 5.11 and the fourth hinging part 5.12 are hinged to make the first short cross tube 5.3 and the second short cross tube 5.4 located in the same plane during relative rotation and prevent difference of level between the first short cross tube 5.3 and the second short cross tube 5.4 after connected; furthermore, the first long cross tube 5.1, the second long cross tube 5.2, the first connecting tube 5.5 and the second connecting tube 5.6 are all hinged at the outside of the first short cross tube 5.3 and the second short cross tube 5.4, thereby ensuring the first long cross tube 5.1, the second long cross tube 5.2, the first connecting tube 5.5 and the second connecting tube 5.6 rotate in the same plane and preventing malposition from influencing folded contraction due to own thicknesses of tubes in the folding process.

The roller set 6 comprises two front wheels 6.1 and two rear wheels 6.2, the front wheels 6.1 are connected to the lower cross beam 2.2 of the front support 2, and the front wheels 6.1 are provided with a brake part 6.3 respectively; the rear wheels 6.2 are connected to the lower cross beam 3.2 of the rear support 3. If the trolley moves on soft ground, for example, soil earth or sandy beach, it is preferable that the front wheels 6.1 and the rear wheels 6.2 are as wide as 10-15 cm, which favors of preventing the front wheels 6.1 and the rear wheels 6.2 from sinking downward and ensuring steady pushing and pulling of the trolley on soft ground. If the trolley moves on hard ground, for example, a rocky road or a cement road, width of 5-10 cm would be preferred for the front wheels 6.1 and the rear wheels 6.2, thereby saving materials and reducing cost.

The pull rod assembly 1 comprises a first telescopic rod 1.1, a second telescopic rod 1.2 and a handle 1.3; the lower end of the first telescopic rod 1.1 is rotatably connected with the lower cross beam 2.2 of the front support 2, and the upper end of the first telescopic rod 1.1 is sleeved outside the lower end of the second telescopic rod 1.2; the sleeved part of the first telescopic rod 1.1 and the second telescopic rod 1.2 is provided with a lock latch 1.4; the handle 1.3 is arranged at the upper end of the second telescopic rod 1.2; the upper cross beam 2.1 of the front support 2 is provided with a limit clamp 8 for clamping the first telescopic rod 1.1. When in use, by pulling the handle 1.3 to pull out the second telescopic rod 1.2 from the first telescopic rod 1.1 to increase length so as to push/pull the trolley to move. When the trolley is parked, the first telescopic rod 1.1 is vertically embedded in the limit clamp 8 to prevent the pull rod assembly 1 from falling on the ground after disengaging from the hand and avoiding picking it up by stooping in next use. The limit clamp 8 plays a role in positioning the pull rod assembly 1, and the pull rod assembly 1 only needs to be pulled out from the limit clamp 8 if used, therefore, use is easy.

The underframe folding assembly 4 comprises a front underframe 4.1 and a rear underframe 4.2, the front end of the front underframe 4.1 is hinged inside the lower ends of the vertical beams 2.3 of the front support 2, the front end of the rear underframe 4.2 is hinged inside the lower ends of the vertical beams 3.3 of the rear support 3, and the rear end of the rear underframe 4.2 is hinged with the rear end of the front underframe 4.1. The front underframe 4.1 and the rear underframe 4.2 may rotate relative to each other, are mutually folded onto the same vertical plane when the trolley is folded so as to produce small volume, and mutually unfolded onto the same horizontal plane when the trolley is unfolded for bearing articles.

Both the front underframe 4.1 and the rear underframe 4.2 are provided with a plurality of bearing beams 4.3 respectively for the purpose of improving stability and firmness. The bearing beams 4.3 may be disposed along the length or width direction of the underframe folding assembly 4.

When in use, grasp the front support 2 in one hand and the rear support 3 in the other hand, and prop open toward two sides, then press the front underframe 4.1 and the rear underframe 4.2 downward and then rotate relatively to push the front support 2 and the rear support 3 to be continuously propped open towards the two sides, meanwhile, the front support 2 and the rear support 3 drive the side frame folding assembly 5 to stretch until the front underframe 4.1 and the rear underframe 4.2 abut against the supporting tube 7, in such a case, the trolley is fully propped open. A cloth cover matched with the trolley in shape when the trolley is unfolded is disposed within the trolley for containing articles. The cloth cover and the trolley are simultaneously folded and unfolded. In case of folding, the front underframe 4.1 or the rear underframe 4.2 is pulled to be lifted upward, the front underframe 4.1 and the rear underframe 4.2 drive the front support 2 and the rear support 3 to close up to the center when they rotate relatively and are inward folded, at the same time, and the front support 2 and the rear support 3 drive the side frame folding assembly 5 to close up to the center. The trolley presents in a platy shape in folding for easy storage.

By arranging the underframe folding assembly and the side frame folding assembly, the trolley is contractile for folding in the front-back direction, occupied space is reduced when the trolley is folded, and articles are transported when the trolley is unfolded, thus being convenient to carry. Each side frame folding assembly comprises a first long cross tube, a second long cross tube, a first short cross tube, a second short cross tube, a first connecting tube and a second connecting tube that are all in hinged match, i.e., a double-cross folding structure is formed, therefore, structure is firm and bearing shock resistance is good. Height of the folded trolley is less than the length of the unfolded trolley so as to reduce folding volume. Besides, the first and second connecting tubes render the cloth cover in the trolley be conveniently propped open. Further, not only is a support point provided in the center, but also the first and second connecting tubes are arranged at two sides for horizontal support, avoiding collapse of the peripheral edges of the cloth cover to cause falling off of articles and ensuring capability of the trolley.

It should be noted that, the above embodiments are merely illustrative, rather than restrictive, to the technical solutions of the present disclosure. Although the present disclosure has been explained in detail with reference to the above embodiments, it should be understood by those skilled in the art that, modifications to the technical solutions of the embodiments or even equivalent substitutions for partial technical features therein are allowed. However, these modifications or substitutions shall not make the essence of the technical solutions depart from the spirit and scope defined by the technical solutions of the present disclosure.

I claim:

1. A foldable trolley, comprising a pull rod assembly, a front support, a rear support, an underframe folding assembly, a side frame folding assembly and a roller set, wherein one end of the underframe folding assembly is hinged with the bottom of the front support, and the other end of the underframe folding assembly hinged with the bottom of the rear support;
both sides of the front support and the rear support are connected with the side frame folding assemblies;
the roller set is respectively connected to the bottom of the front support and the bottom of the rear support;
the pull rod assembly is connected to the front support;
the trolley presents a platy shape when in folding, and a rectangular shape when in unfolding.

2. The foldable trolley of claim 1, wherein both the front and rear supports are in the shape of closed rectangles, and are provided with an upper cross beam, a lower cross beam and two vertical beams respectively.

3. The foldable trolley of claim 2, wherein auxiliary beams are provided below the upper cross beams of both the front and rear supports.

4. The foldable trolley of claim 2, wherein each side frame folding assembly comprises a first long cross tube, a second long cross tube, a first short cross tube, a second short cross tube, a first connecting tube and a second connecting tube; the lower end of the first long cross tube is hinged with the lower end of the vertical beam of the front support; the upper end of the first long cross tube is hinged with the upper end of the second long cross tube to form a first hinging position; the lower end of the second long cross tube is hinged with the lower end of the vertical beam of the rear support; the lower end of the first short cross tube is hinged with the lower end of the second short cross tube to form a second hinging position; the upper end of the first short cross tube is hinged with one end of the first connecting tube; the other end of the first connecting tube is hinged with the upper end of the vertical beam of the front support; the upper end of the second short cross tube is hinged with one end of the second connecting tube; the other end of the second connecting tube is hinged with the upper end of the vertical beam of the rear support; the first short cross tube and the first long cross tube are mutually crosswise hinged; and the second short cross tube and the second long cross tube are mutually crosswise hinged.

5. The foldable trolley of claim 4, wherein a supporting tube is provided between the second hinging positions and the supporting tube is located below the underframe folding assembly.

6. The foldable trolley of claim 4, wherein when the trolley is unfolded, an included angle A of 80-90° is formed between the first connecting tube and the vertical beam of the front support, and another included angle B of 80-90° is formed between the second connecting tube and the vertical beam of the rear support; the first connecting tube, the second connecting tube and the first hinging position are at the same horizontal plane; and when the trolley is folded, the first connecting tube and the vertical beam of the front support have an included angle a of less than 10°, and the second connecting tube and the vertical beam of the rear support have an included angle b of less than 10°.

7. The foldable trolley of claim 2, wherein the roller set comprises two front wheels and two rear wheels; the front wheels are connected to the lower cross beam of the front support and the rear wheels are connected to the lower cross beam of the rear support.

8. The foldable trolley of claim 2, wherein the pull rod assembly comprises a first telescopic rod, a second telescopic rod and a handle; the lower end of the first telescopic rod is rotatably connected with the lower cross beam of the front support, and the upper end of the first telescopic rod is sleeved outside the lower end of the second telescopic rod; the sleeved part of the first and second telescopic rods is provided with a lock latch; the handle is mounted at the upper end of the second telescopic rod; the upper cross beam of the front support is provided with a limit clamp for clamping the first telescopic rod.

9. The foldable trolley of claim 2, wherein the underframe folding assembly comprises a front underframe and a rear underframe, the front end of the front underframe is hinged inside the lower end of the vertical beam of the front support; the front end of the rear underframe is hinged inside the lower end of the vertical beam of the rear support, and the rear end of the rear underframe is hinged with the rear end of the front underframe.

10. The foldable trolley of claim 9, wherein both the front and rear underframes are provided with a plurality of bearing beams respectively.
